(19) United States
(12) Patent Application Publication
(10) Pub. No.: US 2016/0106140 A1
(43) Pub. Date: Apr. 21, 2016

(54) FRUIT CUTTING DEVICE WITH PUSHER

(71) Applicant: Helen of Troy Limited, Belleville (BB)

(72) Inventors: Jeremy Donald O'Halloran, Pittsburgh, PA (US); Dino Anthony Mariano, Bridgeville, PA (US); Gregoire Aby-Eva, Pittsburgh, PA (US); Michael Laskowski, Pittsburgh, PA (US); Mark Steven Drayer, New York, NY (US)

(21) Appl. No.: 14/519,794

(22) Filed: Oct. 21, 2014

(51) Int. Cl. A23N 4/02

(52) U.S. Cl. CPC A23N 4/02

(57) ABSTRACT

A fruit cutting device includes a divider and a pusher. The divider includes a closed-shaped divider frame, blades connected with and positioned within the divider frame, and divider handles on opposing sides of the divider frame. The blades include an upper edge and a lower cutting edge. The divider is configured to be pushed in a cutting direction through a fruit to divide the fruit into sliced segments. The pusher is configured to push the sliced segments through gaps between blades in a pushing direction, which is away from the cutting edges of the blades, and is configured to connect with the divider.

### BACKGROUND

Apple slicers that are pushed downward through an apple to simultaneously slice and core the apple include a frame having handles, a central circular blade and radial blades that connect the central circular blade with the frame. The central circular blade cuts the core of the apple into a cylinder. The radial blades divide the remaining apple into several wedge-shaped slices.

These known apple slicers can be difficult to push entirely through the apple. When these apple slicers are pressed down through an apple resting on a table or countertop, the frame may contact the table or countertop before the blades travel entirely through the apple. Also, the core of the apple can often get stuck in the central circular blade, and can be difficult to remove.

Some known apple slicers work with a pusher to press the lower section of the apple upwards toward the cutting edges of the blades. These pushers can be effective in cutting the apple entirely, but these pushers are directed toward the sharp edges of the blade, which can be undesirable.

### SUMMARY

An example of a fruit cutting device, which can be used to cut an apple or other fruits and can overcome the aforementioned shortcomings, includes a divider and a pusher. The divider includes a closed-shaped divider frame, blades connected with and positioned within the divider frame, and divider handles on opposing sides of the divider frame. The blades include an upper edge and a lower cutting edge. The divider is configured to be pushed in a cutting direction through a fruit to divide the fruit into sliced segments. The pusher is configured to push the sliced segments through gaps between blades in a pushing direction, which is away from the cutting edges of the blades. The pusher is further configured to connect with the divider.

The pusher can be selectively securable to the divider. The pusher covers the upper edges of the blades when the pusher is connected to the divider. The pusher can include pusher handles that engage the divider handles to connect the pusher to the divider. Also, a lower edge of the pusher can engage an upper edge of the divider frame when the pusher is secured to the divider. The pusher can include an arm pivotally connected with the divider.

The divider frame can be a circular ring shape. In such an instance, the blades include a central circular blade and a plurality of radial blades extending from the central circular blade to the divider frame. The pusher can include a pusher frame and a lid connected to or integrally formed with the pusher frame. The pusher frame can be a circular ring shape complementary with the divider frame. The fruit cutting device can further include a projection extending downwardly from the lid aligned along a central axis of the pusher. The pusher frame is centered with respect to the central axis and the projection is configured to engage a core of the fruit while the pusher is pushing the sliced segments through gaps between blades in the pushing direction. The projection can be cross-shaped in a cross section taken normal to the central axis. The lid can be dome shaped or flat.

The pusher can include pusher handles having a complementary shape with the divider handles. The pusher handles cover the divider handles when the pusher is connected with the divider.

A method of cutting a fruit includes pushing a divider through a fruit toward a surface upon which the fruit is resting, and after pushing the divider nearly through the fruit, pushing a pusher against sliced segments of the fruit through gaps between blades of the divider away from cutting edges of the blades. The method may further include disconnecting the pusher from the divider and connecting the pusher to the divider after pushing the sliced segments of fruit through the gaps. The pusher can include pusher handles and the divider can include divider handles, and disconnecting the pusher from the divider can include disengaging a divider handle from a pusher handle prior to pushing the divider through the fruit. Connecting the pusher to the divider can result in covering upper edges of blades with the pusher. Where the blades of the divider include a central circular blade and a plurality of radial blades extending from the central circular blade to a divider frame, and the pusher includes a lid and a projection extending downwardly from the lid, the aforementioned method could further include pushing the projection against a core segment of the fruit after pushing the divider nearly through the fruit. Pushing the pusher can include pivoting a pusher arm toward an upper edge of the blades.

### BRIEF DESCRIPTION OF THE DRAWINGS

FIG. 1 is a perspective view of a fruit cutting device including a divider and a pusher.

FIG. 2 is a perspective view of the fruit cutting device of FIG. 1 with the pusher disconnected from the divider.

FIG. 3 is a perspective view of the fruit cutting device after the divider has been pushed through an apple.

FIG. 4 is a perspective view of an underside of the fruit cutting device depicted in FIG. 1.

FIG. 5 is a perspective view of an alternative embodiment of a fruit cutting device including a divider and a pusher.

### DETAILED DESCRIPTION

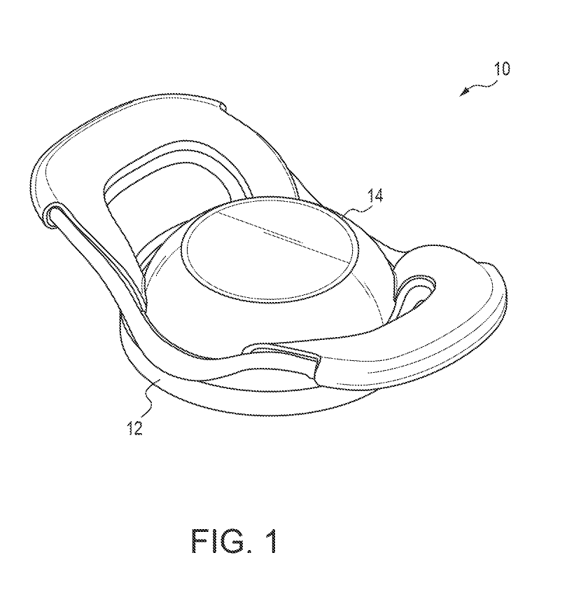

FIG. 1 depicts an example of a fruit cutting device 10 including a divider 12 and a pusher 14. The divider 12 is similar to known apple slicers that are pushed downward through an apple to simultaneously slice and core the apple. The divider 12 can also be used to slice and segment other fruits and may take other configurations than those shown in the figures. The pusher 14 aides in the removal of sliced fruit segments from the divider 12.

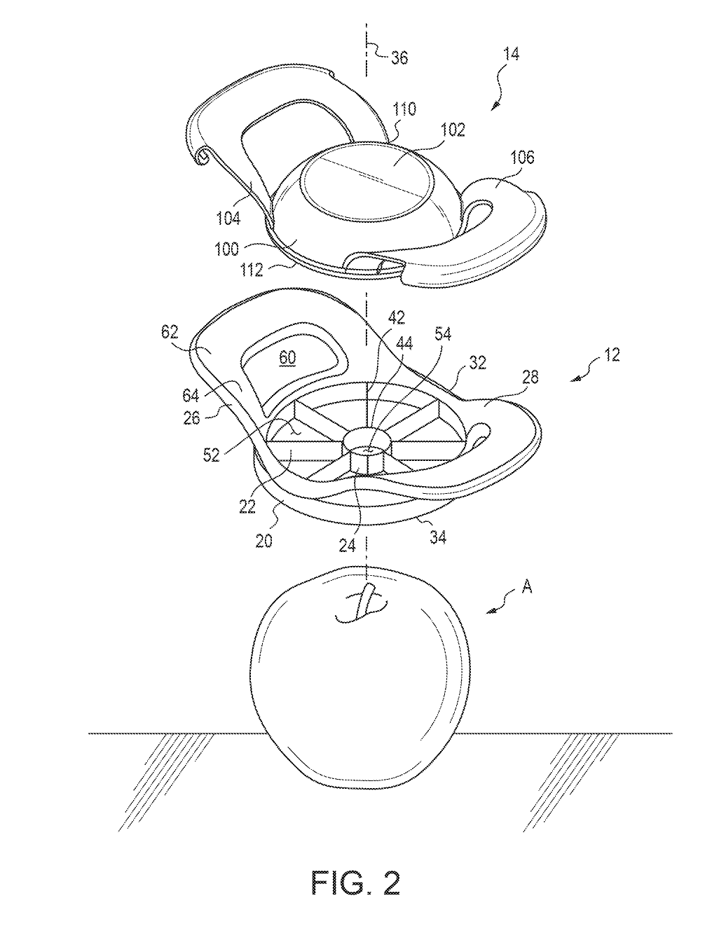

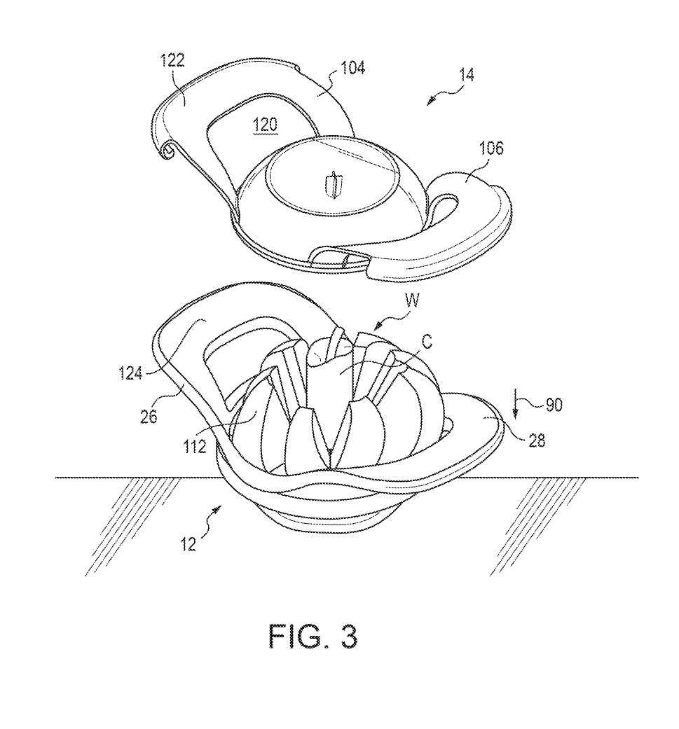

The divider 12 is configured to be pushed in a cutting direction, typically downward, through a fruit such as the apple A in shown in FIG. 2 to divide the fruit into sliced segments such as the wedges W shown in FIG. 3. With reference to FIG. 2, the divider 12 includes a divider frame 20, blades 22, 24 connected with the divider frame, and divider handles 26, 28 on opposing sides of the divider frame 20. In the illustrated embodiment, the divider frame 20 is a circular ring shape, which provides a closed-shaped divider frame. The divider frame 20 could be other closed shapes such as a polygonal configuration. The divider frame 20 and the divider handles 26, 28 are made from a rigid plastic material, but could be made from other rigid materials. The divider frame 20 includes an upper edge 32 and a lower edge 34, both of which are circular in the illustrated embodiment and centered about a central axis 36.

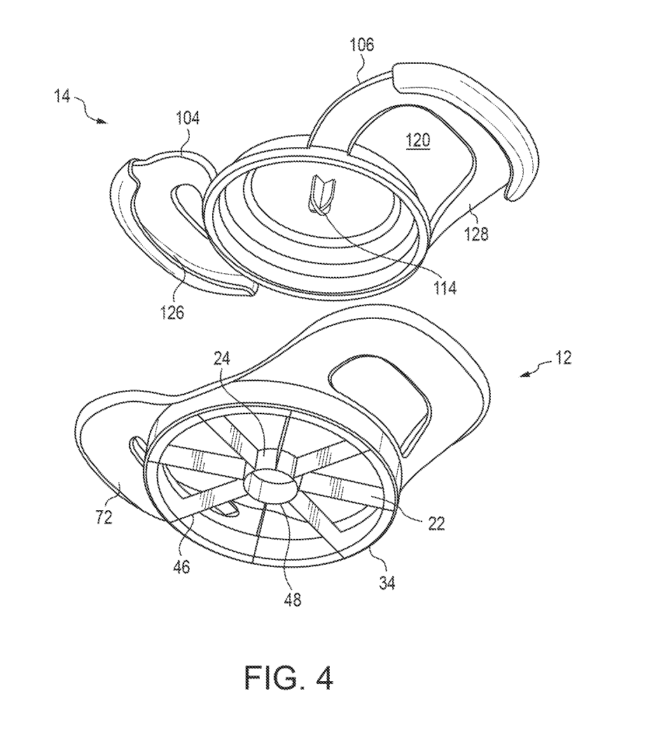

The blades 22, 24 connect with and are positioned within the divider frame 20. The blades 22, 24 each include an upper edge 42, 44, respectively, and a lower cutting edge 46, 48 (FIG. 4), respectively. In the illustrated embodiment, the blades 22, 24 include a central circular blade 24 and a plurality of radial blades 22 extending from the central circular blade 24 to the divider frame 20. Wedge-shaped gaps 52 are provided between adjacent radial blades 22 and the central circular blade 24 and the frame 20. The central circular blade 24 surrounds a circular gap 54. The blades 22, 24 as shown in the figures are similar to the configuration of known apple slicers; however, the configuration of the blades can take other known configurations that may be useful to slice fruits other than apples.

With reference back to FIG. 2, the illustrated fruit cutting device 10 includes two divider handles 26, 28 on opposing sides of the divider frame 20 extending outwardly from the divider frame 20 and away from the central axis 36. In the illustrated embodiment, the divider handles 26, 28 are formed as a single piece with the divider frame 20. In alternative embodiments, the divider handles 26, 28 can be separate components that are connected with the divider frame 20 via fasteners, adhesives or the like. The divider handles 26, 28 facilitate gripping and maneuvering of the divider 12 while cutting a piece of fruit. The divider handles 26, 28 are shaped and positioned such that when the divider 12 is placed on a flat work surface with the lower cutting edges 46, 48 of the blades 22, 24 facing downwards, the divider handles 26, 28 are raised above the work surface, which allows the divider handles 26, 28 to be grasped and held firmly when the lower edge 34 of the divider frame 20 is in contact with the work surface.

The first divider handle 26 is a mirror image of the second divider handle 28. As such, features found in or on the first divider handle 26 are also found in or on the second divider handle 28. Therefore, these features will be described with particularity with reference to one of the divider handles with the understanding that the other divider handle would include these same features. The divider handles 26, 28 are each generally U-shaped and define an opening 60 between the handle 26, 28 and the divider frame 20. The divider handles 26, 28 each include a distal section 62 that is generally horizontally arranged when the lower edge 34 of the divider frame 20 is resting on a horizontal work surface. The divider handles 26, 28 also each include an upper surface 64 that faces away from the lower edge 34 of the divider frame 20 and the lower cutting edges 46, 48 of the blades 22, 24. As more clearly seen in FIG. 4, the divider handles 26, 28 also include a lower surface 72.

The pusher 14 is configured to cooperate with the divider 12 to push the sliced segments W of fruit through the gaps 52 between the blades 22 in a pushing direction (see arrow 90), which is away from the cutting edges 46, 48 of the blades 22, 24. With reference back to FIG. 2, the pusher 14 includes a pusher frame 100, a lid 102 integrally formed or connected with the pusher frame 100, and pusher handles 104, 106 on opposing sides of the pusher frame 100.

The pusher 14 is selectively securable to the divider 12 in the configuration shown in FIG. 1. The pusher 14, and more particularly the lid 102, covers the upper edges 42, 44 of the blades 22, 24 when the pusher 14 is secured to the divider 12. The pusher handles 104, 106 engage the divider handles 26, 28 to secure the pusher 14 to the divider 12. Also, the pusher frame 100 engages the divider frame 20 when the pusher 14 is secured to the divider 12.

The pusher frame 100 is similar in shape to the divider frame 20. The pusher frame 100 is generally circular when viewed normal to the central axis 36. In the illustrated embodiment, the pusher frame 14 is a circular ring shape. The pusher frame 100 includes an upper opening 110 and a circular lower edge 112 vertically spaced from the upper opening. The circular lower edge 112 of the pusher frame 14 is also a lower edge of the pusher 14 and it engages the upper edge 32 of the divider frame 20 when the pusher 14 is secured to the divider 12.

The lid 102 connects with the pusher frame 100 to cover the upper opening 110. In the illustrated embodiment, the lid 102 is clear or see-through, which allows the operator of the pusher 14 to easily view the piece of fruit that is to be removed from the divider 12. In the illustrated embodiment, the lid 102 is dome shaped. The lid 102 can also be flat. A projection 114 extends downwardly from the lid 102. The projection 114 is aligned along the central axis 36, which is also a central axis of the pusher frame 14. The pusher frame 14 is centered with respect to the central axis 36 and the projection 114 is cross-shaped in a cross section taken normal to the central axis 36. The projection 114 is configured to engage the fruit, and more specifically the core C (FIG. 3) in the case of an apple A, for example while the pusher 14 is pushing the sliced wedges W through the gaps 52 between the blades 22 in the pushing direction. The projection 114 can also be useful to only remove the core C. The projection 114 can take configurations other than the cross shape depicted in the figures.

The pusher handles 104, 106 have a complementary shape with the divider handles 26, 28. In the illustrated embodiment, the pusher handles 104, 106 are formed as a single piece with the pusher frame 100. Alternatively, the pusher handles 104, 106 can be separate components that are connected with the pusher frame 100 via fasteners, adhesives or the like. The pusher handles 104, 106 facilitate gripping and maneuvering of the pusher 14 while extracting a piece of fruit from the divider 12. As seen in FIG. 1, the pusher handles 104, 106 cover the divider handles 26, 28 when the pusher 14 is connected with the divider 12. The first pusher handle 104 is a mirror image of the second pusher handle 106. As such, the shape of the first pusher handle 104 is similar to the shape of the second pusher handle 106, and each of the pusher handles includes similar features.

The pusher handles 104, 106 are each generally U-shaped and define an opening 120 between each pusher handle 104, 106 and the pusher frame 100. The pusher handles 104, 106 each include a distal section 122 that is generally horizontally arranged when the circular lower edge 112 of the pusher 14 is resting on a horizontal work surface. The pusher handles 104, 106 also each include an upper surface 124 that faces away from the circular lower edge 112 of the pusher 14. As more clearly seen in FIG. 4, the pusher handles 104, 106 also include a pocket 126 provided on a lower surface 128 of the distal section 122. Each pocket 126 receives a respective distal section 62 of a divider handle 26, 28 to secure the pusher 14 to the divider 12. When the distal section 62 of the divider handle 26, 28 is received in the pocket 126, the circular lower edge 112 of the pusher 14 engages the upper edge 32 of the frame 20 of the divider 12. When the distal section 62 of the divider handle 26, 28 is received in the pocket 126, the opening 60 in the divider handle 26, 28 aligns with the respective opening 120 in the pusher handle 104, 106.

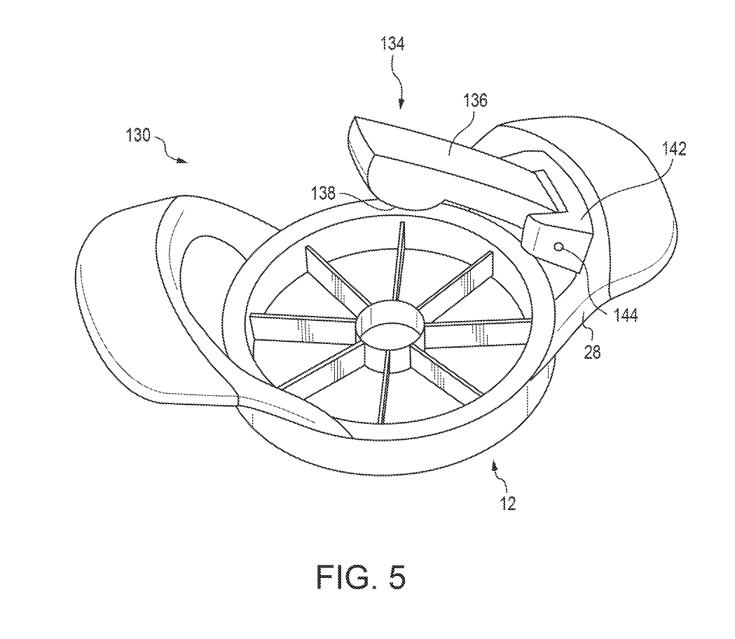

FIG. 5 depicts an alternative embodiment of a fruit cutting device 130 including a divider 12, which is similar in all respects to the divider 12 described above, and a pusher 134. The pusher 134 includes an arm 136 pivotally connected with the divider 12 and a contact surface 138 for contacting the fruit, e.g., the core A in FIG. 3. In the embodiment illustrated in FIG. 5, the arm 136 connects with a support 142 that is fastened to the arm 28 of the divider 12. The arm 136 connects to the support 142 using an axle 144 so that the arm can pivot about a horizontal axis centered with respect to the axle 144. The pusher 134 operates in a similar manner to the pusher 14 described above in that it is configured to push sliced segments (by having a larger contact surface 138 than that shown in FIG. 5), more particularly to push the core C (FIG. 3) in a pushing direction through the gap 54 of the circular blade 44. The contact surface 138 generally faces and moves towards the upper edges 42, 44 of the blades 22, 24 as the arm 136 pivots towards the upper edge.

A method of cutting a fruit will be described with reference to the cutting device 10 depicted in FIGS. 1-4. The method can be used with other similarly configured cutting devices that include a pusher and a divider. The method includes pushing a divider 12 through a fruit, such as the apple A depicted in FIG. 2, toward a surface upon which the fruit is resting. After pushing the divider 12 nearly through the fruit, the method further includes pushing a pusher 14 against sliced segments, e.g., wedges W, of the fruit through gaps 52, 54 between blades of the divider 12 away from cutting edges 46, 48 of the blades 22, 24. The pusher 134 in FIG. 5 could also be used to push wedges W and/or the core C away from the cutting edges 46, 48 of the blades 22, 24.

The method further includes disconnecting the pusher 14 from the divider 12 by disengaging a divider handle 26, 28 from a pusher handle 104, 106 prior to pushing the divider 12 through the fruit. The method can further include connecting the pusher 14 to the divider 12 after pushing the sliced segments, e.g., wedges W, of the fruit through the gaps 52, 54. Also, after pushing the divider 12 nearly through the fruit, the method can include pushing the projection 114 against the core segment C of the fruit, which was cut by the central circular blade 24. The projection 114 is also pushed in a direction away from the cutting edge 48 of the central circular blade 24.

A fruit cutting device and a method of cutting fruit has been described above with particularity. Modifications and alterations will occur to those upon reading and understanding the preceding detailed description. The invention, however, is not limited only to the embodiments described above. Instead, the invention is broadly defined by the appended claims and the equivalents thereof. It will be appreciated that various of the above-disclosed and other features and functions, or alternatives or varieties thereof, may be desirably combined into many other different applications. Also that various presently unforeseen or unanticipated alternatives, modifications, variations or improvements therein may be subsequently made by those skilled in the art which are also intended to be encompassed by the following claims.

1. A fruit cutting device comprising:
a divider including a closed-shape divider frame, blades connected with and positioned within the divider frame, and divider handles on opposing sides of the divider frame, wherein the blades include an upper edge and a lower cutting edge and the divider is configured to be pushed in a cutting direction through a fruit to divide the fruit into sliced segments; and
a pusher configured to push the sliced segments through gaps between blades in a pushing direction, which is away from the cutting edges of the blades, and further configured to connect with the divider.

2. The device of claim 1, wherein the pusher covers the upper edges of the blades when the pusher is connected to the divider.

3. The device of claim 1, wherein the pusher includes pusher handles that engage the divider handles to connect the pusher to the divider.

4. The device of claim 1, wherein a lower edge of the pusher engages an upper edge of the divider frame when the pusher is connected to the divider.

5. The device of claim 1, wherein the pusher includes an arm pivotally connected with the divider and a contact surface for contacting the fruit while pushing, wherein the arm is pivotable toward the upper edges of the blades, and the contact surface generally faces and moves towards the upper edges of the blades as the arm pivots towards the upper edges.

6. The device of claim 1, wherein the divider frame is a circular ring shape and the blades include a central circular blade and a plurality of radial blades extending from the central circular blade to the divider frame.

7. The device of claim 6, wherein the pusher includes a pusher frame and a lid connected to or integrally formed with the pusher frame, wherein the pusher frame is a circular ring shape complementary with the divider frame.

8. The device of claim 7, further comprising a projection extending downwardly from the lid aligned along a central axis of the pusher, wherein the pusher frame is centered with respect to the central axis, wherein the projection is configured to engage a core of the fruit while the pusher is pushing the sliced segments through the gaps between blades in the pushing direction.

9. The device of claim 8, wherein the projection is cross shaped in a cross section taken normal to the central axis.

10. The device of claim 8, wherein the lid is dome shaped.

11. The device of claim 8, wherein the lid is flat.

12. The device of claim 1, wherein the pusher includes pusher handles having a complementary shape with the divider handles.

13. The device of claim 12, wherein the pusher handles cover the divider handles when the pusher is connected with the divider.

14. A method of cutting a fruit comprising:
pushing a divider through a fruit toward a surface upon which the fruit is resting; and
after pushing the divider nearly through the fruit, pushing a pusher against sliced segments of the fruit through gaps between blades of the divider away from cutting edges of the blades.

15. The method of claim 14, further comprising:
disconnecting the pusher from the divider prior to pushing the divider through the fruit; and
connecting the pusher to the divider after pushing the sliced segments of the fruit through the gaps.

16. The method of claim 15, wherein the pusher includes pusher handles and the divider includes divider handles, wherein disconnecting the pusher from the divider further includes disengaging the divider handles from the pusher handles.

17. The method of claim 15, connecting the pusher to the divider further includes covering upper edges of the blades with the pusher.

18. The method of claim 16, wherein the blades of the divider include a central circular blade and a plurality of radial blades extending from the central circular blade to a divider frame, and the pusher includes a lid and a projection extending downwardly from the lid, the method further comprising:
after pushing the divider nearly through the fruit, pushing the projection against a core segment of the fruit, which was cut by the central circular blade, in a direction away from a cutting edge of the central circular blade.

19. The method of claim 16, wherein pushing a pusher includes pivoting a pusher arm toward an upper edge of the blades.
